(19) United States
(12) Patent Application Publication
(10) Pub. No.: US 2012/0274125 A1
(43) Pub. Date: Nov. 1, 2012

(54) POWER WASH AND OVERSPRAY WHEEL PROTECTOR

(76) Inventor: Stephan Waldt, Durham, NC (US)

(21) Appl. No.: 13/460,339

(22) Filed: Apr. 30, 2012

Related U.S. Application Data
(60) Provisional application No. 61/479,975, filed on Apr. 28, 2011.

(51) Int. Cl. B60B 7/00

(52) U.S. Cl. 301/37.106

(57) ABSTRACT

A power wash and overspray wheel protector is disclosed. According to one aspect, an overspray wheel protector is composed of a planar material having at least one hand hold opening and a plurality of indicia disposed on at least one surface of the planar material, where the plurality of indicia represent a plurality of diameters for allowing a user to adjust the size of the protector to a desired diameter for use to protect a wheel from overspray.

### PRIORITY CLAIM

This application claims the benefit of U.S. Provisional Patent Application Ser. No. 61/479,975, filed Apr. 28, 2011; the disclosure of which is incorporated herein by reference in its entirety.

### TECHNICAL FIELD

The subject matter described herein relates to devices for aiding the cleaning or treatment of vehicle tires. More particularly, the subject matter described herein relates to a power wash and overspray wheel protector.

### BACKGROUND

Vehicle tires, such as automotive or truck tires, are typically made of vulcanized rubber and are mounted onto a metal wheel. Colloquially, however, the term “wheel” is sometimes used to refer to the combination of wheel and tire, and the terms “rim” and “tire rim” are sometimes used to refer to the wheel only, i.e., without the tire. As used herein, the term wheel is used according to its technical definition, i.e., the structure around which the tire is mounted, not including the tire.

During operation, tires are usually exposed to the environment and may suffer damage due to such exposure, reducing the life of the tires. Tire maintenance may include washing the tire or applying a tire cleaner, protectant, or coating to the surface of the tire itself. Popular tire treatment products include protective coatings that include silicone in the chemical formula, and are often sold in a form which is applied to the tire by spraying the product onto the tire rather than applying the product with cloth, brush, or sponge.

One problem with tire protection products that include silicone is that silicone itself is very slippery and at the same time difficult to remove from the surface once applied. When a silicone based tire protectant is sprayed onto a vehicle tire, the person applying the product may accidently spray the product onto the wheel, where it may end up on vehicle brake surfaces, such as the rotor or pads of disk brakes or the drum and pads of drum brakes. When silicone is applied to brake surfaces, the silicone greatly reduces the coefficient of friction on those surfaces, which renders the brakes partially or even completely useless, with potentially disastrous effects.

In addition, the relatively exposed nature of vehicle brake surfaces means that there is little or no protection from contact with water, detergent, or wax while the tire is being washed. This is particularly true when the tire is being subject to a high-pressure power wash, where the high-pressure stream may damage wheel or brake components or move them out of place or out of alignment.

Accordingly, there exists a need for a product that can help protect a wheel from overspray during application of tire products, as well as protect a wheel from exposure to water, detergent, or waxes, during a wash or power wash. More specifically, there exists a need for a power wash and overspray wheel protector.

### SUMMARY

According to one aspect, the subject matter described herein includes an overspray wheel protector, the wheel protector including a planar material having at least one hand hold opening and a set of indicia disposed on at least one surface of the planar material, wherein the set of indicia represent multiple diameters for allowing a user to adjust the size of the protector to a desired diameter for use to protect a wheel from overspray.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a top schematic view of a wheel protector according to an embodiment of the subject matter described herein, showing a set of concentric indicators, perforations, or tear-away tabs for configuring the wheel protector to a desired diameter;

FIG. 2 is a perspective view of a wheel protector according to an embodiment of the subject matter described herein showing the separation along one of the concentric indicators, perforations, or tear-away tabs to produce a wheel protector of a desired size;

FIG. 3 illustrates a wheel protector according to an embodiment of the subject matter described herein being placed in position for use; and

FIG. 4 is a flow chart illustrating an exemplary method for protecting a wheel from overspray during treatment of a tire or vehicle associated with that wheel according to an embodiment of the subject matter described herein.

### DETAILED DESCRIPTION

In accordance with the subject matter disclosed herein, a power wash and overspray wheel protector is disclosed. Reference will now be made in detail to exemplary embodiments of the present invention, examples of which are illustrated in the accompanying drawings. Wherever possible, the same reference numbers will be used throughout the drawings to refer to the same or like parts.

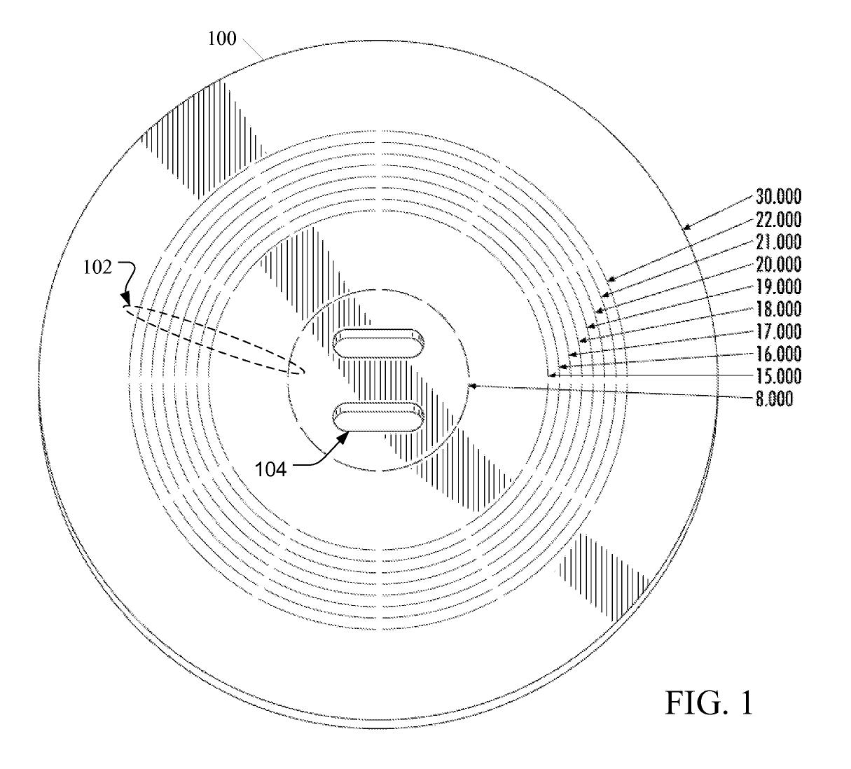

FIG. 1 is a top schematic view of a wheel protector, herein referred to as shield 100, according to an embodiment of the subject matter described herein, showing a set of concentric indicators, perforations, or tear-away tabs for configuring the wheel protector to a desired diameter. In one embodiment, shield 100 may be planar or essentially planar. In one embodiment, shield 100 may be fabricated from plastic, such as 4 mil thick corrugated plastic. In other embodiments, shield 100 may be fabricated from foam board, plastic coated foam board, metal or metallic material, cardboard, coated cardboard, wood, composite, or other suitable materials. Shield 100 may be made of material which is water proof or water-resistant. Shield 100 may be made of a rigid material or a semi-rigid material. For example, shield 100 may be made of a material that is rigid enough to withstand a high-pressure stream of liquid, and/or flexible enough to allow shield 100 to be flexed slightly to secure it within the inner diameter of a wheel rim. In one embodiment, shield 100 may be comprised of a material which is flexible enough to be folded or of a less flexible material that includes a seam or fold line for that purpose. Alternatively, shield 100 may be comprised of a material that may be rolled up or curled. The ability to fold or roll shield 100 allows for easy storage of the device.

In one embodiment, shield 100 may be provided to consumers in various fixed diameters that correspond to various tire rim sizes. In the embodiment illustrated in FIG. 1, shield 100 may be provided in a single sheet that may be sized by the user to the needed diameter. In one embodiment, shield 100 may be marked with sets of indications 102, such as circumferential lines of various diameters indicating common rim sizes. These indications may be printed onto the surface of shield 100 to aid in cutting. In the embodiment illustrated in FIG. 1, for example, the shield 100 includes circumferential lines having diameters of 8, 15, 16, 17, 18, 19, 20, 21, 22, and 30 inches, but other diameters are contemplated.

In an alternate embodiment, the user may be provided with a set of shields, where each shield in the set had indications, cuts, or perforations corresponding to a set of diameters. For example, a first shield in the set may have perforations that allow the shield to be easily sized from 8 to 15 inches in increments of half of an inch, while a second shield in the set may have perforations that allow the shield to be easily sized from 15 to 31 inches in increments of an inch. Other combinations of sizes, size increments, and number of shields in the set may also be used.

Alternatively, indications 102 shown on shield 100 may indicate the locations of perforations through the thickness of the sheet that allow the user to cut, tear, or otherwise separate outer portions of shield 100 to leave an inner portion of shield 100 that is the desired diameter. In these embodiments, indications 102 may indicate places where shield 100 has been pre-cut, pre-punched, or pre-perforated to form rings of material that are attached to the rest of the material at a number of places, e.g., connections distributed equally around the circumference of the ring. In one embodiment, indications 102 may be tabs holding shields of different diameters together and that make it easy for the user to pull apart to obtain a shield of the desired size. In one embodiment, indications 102 may be perforated holes through shield 100 allowing the user to easily cut or tear shield 100 at the needed diameter. In one embodiment, shield 100 (or the inner-most shield if the desired size shield may be separated from a single sheet) may also include cutouts 104 near the center of shield 100 for the user to hold while placing the shield against the tire rim.

In one embodiment, shield 100 may be essentially disk-shaped, and may have a smooth circumference, but other shapes may be used, including circles, ovals, polygons, regular or irregular shapes, stars, spirals, and so on.

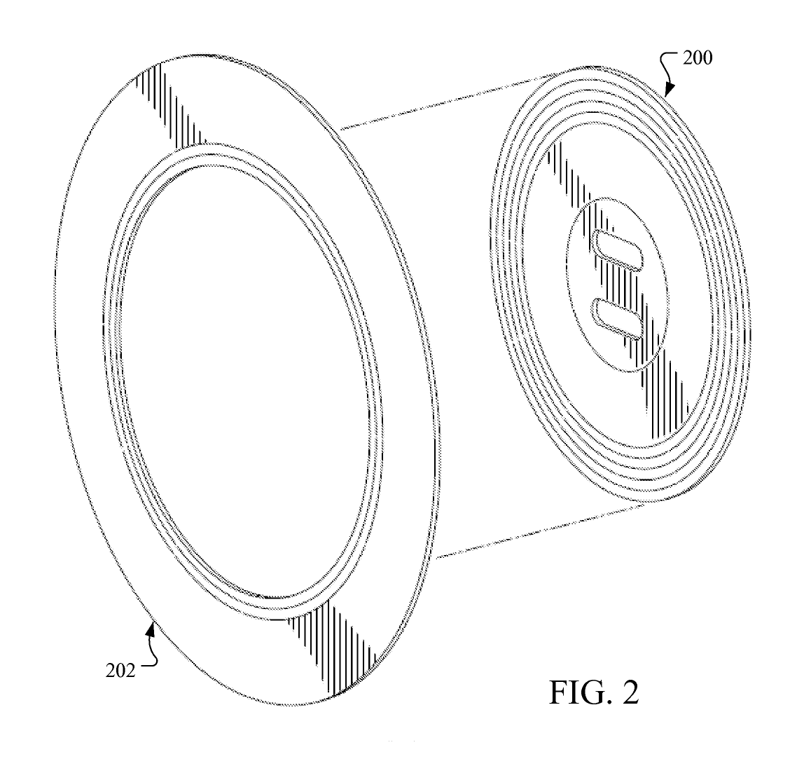

FIG. 2 is a perspective view of a wheel protector according to an embodiment of the subject matter described herein showing the separation along one of the indicators 102 to produce a wheel protector of a desired size. In the embodiment illustrated in FIG. 2, the user has separated shield 100 into two portions: an inner shield 200 of the desired size and the unused remainder 202.

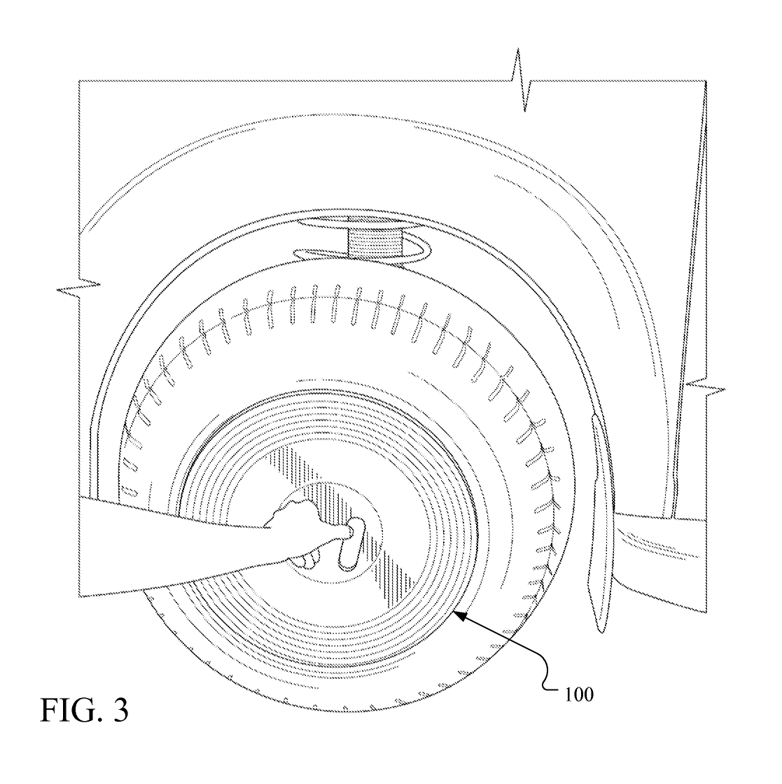

FIG. 3 illustrates a wheel protector according to an embodiment of the subject matter described herein being placed in position for use. In FIG. 3, shield 100 is being placed directly against a tire rim to guard the rim while the tire is being power washed, cleaned, or chemically treated. Shield 100 may be held in place by the user, or it may fit snugly enough within the rim to hold the shield in place, e.g., without requiring the user to hold it there.

If a wheel rim has a lip, ridge, or edge, e.g., where the outer edge of the rim has a smaller diameter than an inner edge of the rim, shield 100 may be constructed of a material that is flexible enough to allow the user to compress the shield to get past the narrow opening formed by the outer edge of the rim, yet, once inside, allow the shield to expand again to fit snugly within the wider inner surface of the rim.

In one embodiment, shield 100 consists of a series of nested concentric rings of material that are designed such that as many outer rings may be removed as needed to create a substantially circular shield of the desired size. These rings may have smooth or substantially smooth perimeters, as shown in FIG. 1, but in alternative embodiments, each of the nested rings may have a perimeter having variations in diameter from the center of the respective ring.

Shield 100 may protect the tire rim against overspray when the tire is being washed or against chemicals when a harsh chemical cleaner is applied to the tire. Furthermore, shield 100 may be used to protect the rims of automobiles, trucks, golf carts, ATVs, trailers, or any other wheeled vehicle. In one embodiment, shield 100 may be decorated with logos, slogans, advertisements, websites, sports team names, promotions, or other text or artwork.

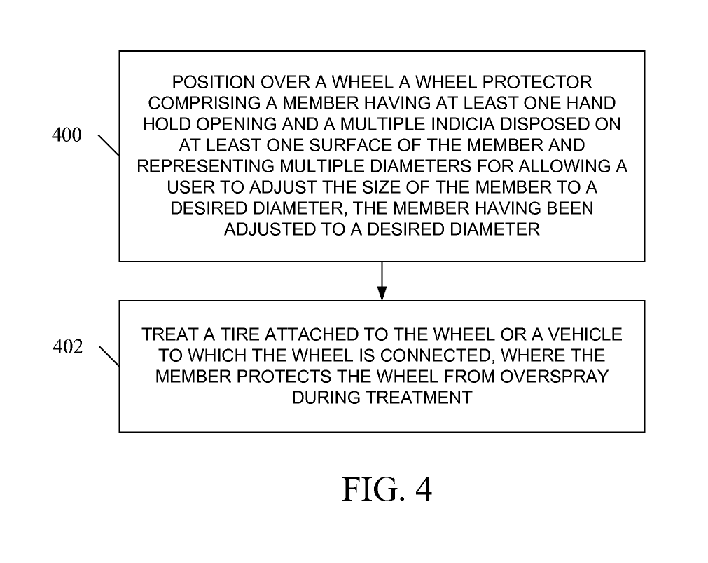

FIG. 4 is a flow chart illustrating an exemplary method for protecting a wheel from overspray during treatment of a tire or vehicle associated with that wheel according to an embodiment of the subject matter described herein. At step 400, a wheel protector that includes a member having one or more hand hold openings and multiple indicia disposed on at least one surface of the member that represent multiple diameters for allowing a user to adjust the size of the member to a desired diameter, the member already having been adjusted to a desired diameter, is positioned over a wheel. At step 402, the member protects the wheel from overspray during treatment of a tire attached to the wheel and/or treatment of a vehicle to which the wheel is connected. Treatment of an item may include washing or rinsing the item, or applying a substance to the item. Applying a substance to the item may include applying a cleaner or protectant to the item. Applying a substance to the item may include spraying the substance onto the item. In one embodiment, the member may protect the wheel while the tire is being treated with silicone products, for example, but the member may also protect the wheel while a car or truck to which the wheel is attached is being washed, cleaned, waxed, etc.

In one embodiment, the user places the wheel protector over the wheel and holds it there while the tire or vehicle is being treated. The hand holds may be used for this purpose. In one embodiment, the hand holds may be a set of holes designed to accommodate the user's thumb and/or one or more fingers. Alternatively, the hand-holds may be a pair of slots 104 such as are illustrated in FIG. 1. In one embodiment, the member may have just one hand hold, such as a single hole or a straight or curved slot. In the embodiment illustrated in FIG. 1, hand holds 104 are located at or near the center of the wheel protector, but other positions may be used instead.

In one alternative embodiment, the wheel protector may fit snugly inside the rim such that the user does not need to continue to hold the wheel protector in position during treatment.

It will be understood that various details of the subject matter described herein may be changed without departing from the scope of the subject matter described herein. Furthermore, the foregoing description is for the purpose of illustration only, and not for the purpose of limitation.

What is claimed is:

1. An overspray wheel protector, comprising:
a member having at least one hand hold opening and a plurality of indicia disposed on at least one surface of the member, wherein the plurality of indicia represent a plurality of diameters for allowing a user to adjust the size of the wheel protector to a desired diameter for use to protect a wheel from overspray.

2. The wheel protector of claim 1 wherein the plurality of indicia comprise markings on the surface of the member to indicate to a user where to cut the member to produce a wheel protector of a desired diameter.

3. The wheel protector of claim 1 wherein the plurality of indicia comprise perforations at least partially through the thickness of the member to allow a user to cut or tear the member along one or more of the perforations to produce a wheel protector of a desired diameter.

4. The wheel protector of claim 1 wherein the plurality of indicia comprise cuts partially through the thickness of the member to allow a user to cut or tear through a remaining uncut thickness of the member to produce a wheel protector of a desired diameter.

5. The wheel protector of claim 1 wherein the plurality of indicia comprise cuts completely through the thickness of the member to allow a user to cut or tear through an uncut portion of the member to produce a wheel protector of a desired diameter.

6. The wheel protector of claim 1 wherein the plurality of indicia represent a plurality of diameters corresponding to tire or wheel rim diameters.

7. The wheel protector of claim 6 wherein the plurality of indicia represent a plurality of diameters corresponding to standard tire or wheel rim diameters.

8. The wheel protector of claim 1 wherein the plurality of indicia comprise a set of nested concentric rings.

9. The wheel protector of claim 1 wherein the member comprises at least one of: corrugated or un-corrugated plastic, foam board, plastic coated foam board, metal or metallic material, cardboard, coated cardboard, wood, and composite.

10. The wheel protector of claim 1 wherein the member comprises a waterproof or water-resistant material.

11. The wheel protector of claim 1 wherein the member comprises a rigid or semi-rigid material.

12. The wheel protector of claim 1 wherein the member comprises a flexible material to allow insertion of the wheel protector past an opening having a circumference smaller than the circumference of the wheel protector.

13. The wheel protector of claim 1 wherein the member comprises a material that is foldable or rollable

14. The wheel protector of claim 1 wherein the member is substantially planar.

15. The wheel protector of claim 1 wherein the member is substantially disk-shaped.

16. The wheel protector of claim 1 wherein the at least one hand hold opening is located at substantially the center of the member.

17. The wheel protector of claim 1 wherein the at least one hand hold opening is for use by the user to position the wheel protector in a desired position over the wheel to protect the wheel from overspray.

18. The wheel protector of claim 1 wherein the at least one hand hold opening comprises a plurality of openings.

19. The wheel protector of claim 18 wherein each of the plurality of hand hold openings accommodates a thumb or at least one finger of the user's hand.

20. A method for protecting a wheel from overspray during treatment of a tire or vehicle associated with the wheel, the method comprising:
positioning over a wheel a wheel protector comprising a member having at least one hand hold opening and a plurality of indicia disposed on at least one surface of the member and representing a plurality of diameters for allowing a user to adjust the size of the member to a desired diameter, the member having been adjusted to a desired diameter; and
treating a tire attached to the wheel or a vehicle to which the wheel is connected, wherein the member protects the wheel from overspray during treatment.

21. The method of claim 20 wherein treatment of the tire or vehicle comprises washing, rinsing, or applying a substance onto the tire or vehicle.

22. The method of claim 21 wherein applying a substance onto the tire or vehicle comprises spraying a cleaner or protectant onto the tire or vehicle.

23. The method of claim 20 wherein the user positions the wheel protector during or prior to treatment.

24. The method of claim 23 wherein the user uses the at least one hand hold opening to position the wheel protector during or prior to treatment.

25. The method of claim 20 wherein the user maintains the position of the wheel protector during treatment.
